(19) United States
(12) Patent Application Publication
(10) Pub. No.: US 2019/0357587 A1
(43) Pub. Date: Nov. 28, 2019

(54) METHOD FOR PRODUCING FOOD MOUSSES

(71) Applicant: L'Air Liquide, Societe Anonyme pour I'Etude et I'Exploitation des Procedes Georges Claude, Paris (FR)

(72) Inventor: Robert TAYLOR, Wavre (BE)

(73) Assignee: L'Air Liquide, Societe Anonyme pour l'Etude et l?E xploitation des Procedes Georges Claude, Paris (FR)

(21) Appl. No.: 16/331,597

(22) PCT Filed: Sep. 6, 2017
(86) PCT No.: PCT/FR2017/052361

§ 371 Date: Mar. 8, 2019

(30) Foreign Application Priority Data
Sep. 8, 2016 (FR) FR 1658327

(51) Int. Cl. A23P 30/40; A23G 9/06; A23G 9/20; A23G 9/46

(52) U.S. Cl. CPC A23P 30/40; A23G 9/46; A23G 9/20; A23G 9/06

(57) ABSTRACT

The invention relates to a method for producing an expanded food system, comprising a step of injecting, into an initial composition, a treatment gas comprising CO₂ and N₂O at a treatment pressure, characterized in that the treatment gas also comprises argon, and where the partial pressure of the CO₂ in the mixture is preferably lower than or equal to 4 bar, and more preferably lower than or equal to 3 bar of CO₂.

### CROSS-REFERENCE TO RELATED APPLICATIONS

This application is a § 371 of International PCT Application PCT/FR2017/052361, filed Sep. 6, 2017, which claims § 119(a) foreign priority to French patent application FR 1658327, filed Sep. 8, 2016.

### BACKGROUND

### Field of the Invention

The present invention relates to the field of processes for producing food foams (expanded food systems), whether they are in particular illustrative of expanded milk desserts, creams, frozen or not, or else sauces.

### Related Art

Furthermore, whether this is on an industrial scale or in the kitchen, processes for producing food foams are simple in principle and well-known. They bring into contact two phases: a liquid (containing surfactants) and a gas phase, which are sheared intensely, for example through a beater (manual or electric) at atmospheric pressure or else in industrial blenders under pressure (typically up to 10 bar).

Another well-known and listed process consists in using specific gases, among which are CO₂ and N₂O, which have properties of dissolution and expansion by depressurization (for example in Chantilly cream cartridges, well-known cartridges).

Nevertheless it is also well known that nitrous oxide N₂O is a gas that is not well liked from the environmental point of view, since it is one of the main greenhouse-effect gases discharged into the atmosphere and has a global warming power of around 300 (i.e 300 times that of the CO₂ reference).

It is consequently understood that this food industry is very interested in any new process of expansion that would display a reduced global warming power.

### SUMMARY OF THE INVENTION

As will be seen in greater detail in what follows, the present invention proposes a new expansion gas, the expansion properties of which can be compared to those of N₂O, but the global warming power of which is substantially reduced, and the processing cost of which is also substantially reduced.

### DETAILED DESCRIPTION OF THE INVENTION

Furthermore, it is to the credit of the present invention to have understood the following phenomena, and have consequently proposed the following alternative conditions:
the N₂O is partially replaced in the mixture by CO₂: indeed, the replacement can only be partial since above a certain content, CO₂ has a strong impact on the pH of the product (from cream, for example) and thus its flavor. Below this upper limit (which will vary depending on the product), the N₂O/CO₂ mixture will show expansion performance levels entirely comparable to those (which are notable) of N₂O alone, without having an impact on the organoleptic properties of the food product.

By way of illustration, it may be considered that, in the case of numerous products, a CO₂ partial pressure exceeding 2.5 bar leads to detection of a change in pH and in flavor, and from 5 bar or even 3 bar of CO₂, the flavor of the product has in most cases become unacceptable;
but to continue to improve the environmental performance levels of the mixture, it is proposed here to add argon to the N₂O—CO₂ mixture (or to an N₂O—CO₂—N₂ mixture as will be seen later): as has been stated, the CO₂ is kept below the limit that would have an impact on the texture and flavor, while, according to the experiments carried out by the applicant, it appears that, while the argon does not appear to dissolve in the fatty phase of the composition, on the other hand it dissolves in the aqueous phase of the composition, and upon expansion it produces a “frothy” mixture. Thus, in the presence of an N₂O—Ar—CO₂ or N₂O—Ar—CO₂—N₂ gas mixture, the foaming effect of the argon combines with the expanding effect of the N₂O and CO₂ gases;
as has been stated, the mixture used can also contain nitrogen (or another inert gas but nitrogen is clearly the most advantageous in terms of cost) to increase the stability of foam and maintain adequate pressure in the can when such a container is used.

The experiments completed by the applicant showed the following results:
a cream made with a 10% Argon-30% CO₂-60% N₂O mixture at 4° C. has an entirely conventional expanded structure, with a slightly acidic but totally acceptable flavor. Such a mixture has a global warming power 40% lower than an N₂O gas alone.

The present invention therefore relates to a process for producing an expanded food system, comprising a step of injecting, into an initial composition, a treatment gas comprising CO₂ and N₂O at a treatment pressure, characterized in that the treatment gas also comprises argon.

According to one preferred embodiment of the invention, the CO₂ partial pressure in the mixture is less than or equal to 4 bar, and more preferentially less or equal to 3 bar.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed, Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing i.e. anything else may be additionally included and remain within the scope of “comprising.” “Comprising” is defined herein as necessarily encompassing the more limited transitional terms “consisting essentially of” and “consisting of”; “comprising” may therefore be replaced by “consisting essentially of” or “consisting of” and remain within the expressly defined scope of “comprising”.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

1-4. (canceled)

5. A process for producing an expanded food system, comprising a step of injecting, into an initial composition, a treatment gas comprising CO₂ and N₂O at a treatment pressure, characterized in that the treatment gas also comprises argon.

6. The process of claim 5, wherein the treatment gas is a CO₂—N₂O—Ar mixture.

7. The process of claim 5, wherein the treatment gas is a CO₂—N₂O—Ar—N₂ mixture.

8. The process of claim 6, wherein the CO₂ partial pressure in the gas is less than or equal to 4 bar of CO₂.

9. The process of claim 6, wherein the CO₂ partial pressure in the gas is less than or equal to 3 bar of CO₂.
